(19) United States
(12) Patent Application Publication
(10) Pub. No.: US 2024/0269871 A1
(43) Pub. Date: Aug. 15, 2024

(54) TRANSFER DEVICE FOR A SEALED ENCLOSURE COMPRISING A DEFORMABLE PORTION

(71) Applicant: GETINGE LIFE SCIENCE FRANCE, Vendôme (FR)

(72) Inventors: Emmanuel MOTTIER, AZE (FR); Samuel BOTTIER, DANZE (FR)

(21) Appl. No.: 18/567,595

(22) PCT Filed: Jun. 2, 2022
(86) PCT No.: PCT/FR2022/051042

§ 371 Date: Dec. 6, 2023

(30) Foreign Application Priority Data
Jun. 7, 2021 (FR) FR2105955

(51) Int. Cl. B25J 21/02; B01L 1/02; G21F 7/005

(52) U.S. Cl. CPC B25J 21/02; B01L 1/02; B01L 2200/025; B01L 2200/141; G21F 7/005

(57) ABSTRACT

A transfer device intended to be mounted in an enclosure provided with a sealed connection device, the transfer device comprising a first portion forming a conduit for the flow of elements in the enclosure, a second rigid portion forming a conduit, and connector for connection to a device for moving the transfer device inside the enclosure, the first portion having elastic deformation properties so as to be able to be elastically deformed by an operator and to allow, after deformation, the transfer device to pass through the connection device.

### TECHNICAL FIELD AND PRIOR ART

The present application relates to a transfer device for a sealed enclosure delimiting a closed volume intended to be connected to another closed volume, the sealed enclosure comprising a sealed connection device between the two closed volumes.

In many industrial sectors, comprising the pharmaceutical, medical, agri-food and nuclear sectors, it is necessary or desirable to perform some tasks in a confined atmosphere, either in order to protect the personnel, for example from radioactivity, toxicity, etc., or on the contrary to be able to perform these tasks in an aseptic or dust-free atmosphere, or finally both simultaneously.

The transfer of an apparatus or a product from one closed volume to another, without at any time the sealing of each of these volumes from the outside being broken, poses a delicate problem to address. This problem may be solved by a dual-door connection device.

For example, such a dual-door device provided with a multi-safety control is known from the document FR 2 695 343. Each volume is closed by a door mounted in a flange. Each door is secured to its flange by a bayonet connection and the two flanges are intended to be secured to each other by a bayonet connection. This system is also referred to as RTP standing for “Rapid transfer port”.

In the case where one of the closed volumes is formed by a container and the other volume by an enclosure, for example a glove box, the transfer is performed in the following manner. The flange of the container comprises on its outer periphery lugs intended to cooperate with an indentation of the flange of the glove box. The flange of the container is inserted into the flange of the glove box, the container is oriented so as to match the lugs with the indentation. A first rotation of the container along the axis of its door allows securing the flange of the container to the flange of the glove box by the bayonet connection. By means of a second rotation of the container, along the same axis and in continuity with the first rotation, the door of the container is pivoted relative to the container, ensuring both a connection by another bayonet connection with the door of the glove box and a separation of the new assembly formed by the two doors affixed to the door and glove box flanges. A handle control located in the glove box allows unlocking a safety mechanism and clears the passage between the two volumes. In the case of an aseptic atmosphere, the external faces of the two doors being in contact with each other in a sealed manner, they cannot contaminate the interior of the volumes or be contaminated by the internal environment of the glove box.

The container flange comprises a seal which, when it is secured to the flange of the glove box, delimits with the two flanges the passage between the interior of the container and the interior of the glove box. The tip of the seal of the container flange that is not in contact with the flange of the glove box is called the “contamination ring” or “ring of concern”. Care should be taken to ensure the integrity of the container flange seal and priority should be given to avoid contact with the contamination ring during transfer, to avoid the contamination of the enclosure.

This type of enclosure is used for the manufacture of products under controlled atmosphere, for example in the pharmaceutical field for the manufacture of drugs and packaging thereof. For example, filling lines are disposed in the enclosures. Objects from the outside can then be transferred towards the interior of the enclosure, for example vials or caps. The objects are contained in a bag provided with a flange and a door, the flange being connected in a sealed manner to the flange of the enclosure. To facilitate the transfer of the objects, for example to pour them into a vibrating bowl of the filling line, a transfer system is implemented in the enclosure, comprising an element forming a funnel, called chute and intended to fit as a support or in the flange of the enclosure inside the enclosure to receive the objects that originate from the bag and guide them towards their destination, for example the vibrating bowl. Positioning the chute in the opening of the container flange allows covering the contamination ring.

An example of such a transfer system is described in the document EP3581339. The chute is hinged with respect to the wall of the enclosure between a docked position, in which it penetrates into the flange of the enclosure and borders the opening of the container which is mounted on the flange of the enclosure outside of the latter, and a separated or rest position, in which the chute is moved away from the opening of the enclosure so as not to disturb the return of the door of the enclosure in place.

The chute is in contact with the objects during their pouring. It is therefore necessary to clean the chute to meet the cleanliness constraints of the containment enclosure. It is then required to be able to extract the chute from the enclosure to be able to clean it and subject it to an autoclaving operation.

To ensure a correct transfer, the chute has a cross section that occupies the entire passage section of the transfer opening through the connection device mounted through the wall of the enclosure to collect all of the objects originating from the container. The end of the chute comes to bear against the flange of the container. As a result, the chute cannot be extracted from the enclosure. To extract the chute from the enclosure, either the enclosure is equipped with another sealed connection device with a diameter allowing the passage of the chute, which implies an additional cost and an additional leak risk, or a flap is provided. However, the opening of the flap implies, during the removal of the chute, a complete opening of the enclosure and a loss of containment.

### DISCLOSURE OF THE INVENTION

Consequently, one aim of the present invention is to offer a transfer device or chute that does not have the abovementioned drawbacks.

The abovementioned aim is achieved by a transfer device or chute configured to be mounted in a containment enclosure in order to ensure the transfer of elements between a sealed volume connected to the enclosure by a sealed connection device and the enclosure, the transfer device comprising at least one first portion intended to penetrate into the connection device, said first portion having elastic deformation properties allowing said portion to be deformed and removed by the connection device of reduced diameter or any other dual-door connection device of reduced diameter. The transfer device also comprises means for connecting to a device for displacing the transfer device inside the enclosure.

Thanks to the invention, it is possible to ensure the removal of the chute from an enclosure only having one or more connection devices having a passage section smaller than that of the chute. Thanks to the invention, it is also possible to ensure the removal of the chute without losing the containment and without cutting the sterility of the enclosure.

Advantageously, the first portion has a flared shape.

Preferably, the chute comprises a second rigid portion of tubular, for example, shape, the cross section of which allows it to be extracted through the connection device.

Particularly advantageously, the means for connecting to the device for displacing the chute are means that are actuatable with one hand.

In other words, a chute is produced of which at least the largest section is flexible in order to be able to be deformed, and in its deformed state, to have an external dimension allowing its transfer between the interior of the cell and the exterior of the cell. The flexible portion advantageously returns to its initial shape after its transfer from the cell to the exterior or vice versa.

The invention is particularly adapted to equip an enclosure provided with an automatic opening connection device which does not require additional glove holes for its opening. One of the objects of the present application is a transfer device intended to be mounted in an enclosure provided with at least one sealed connection device, said transfer device comprising at least one first portion forming a conduit for the flow of elements into said enclosure, and means for connecting to a device for displacing said transfer device inside the enclosure, said first portion having elastic deformation properties so as to be able to be elastically deformed by an operator and to allow after deformation the transfer device to pass through the connection device.

Preferably, the first portion is made of a material selected from elastomers, for example thermosetting silicone, thermosetting EPDM (ethylene propylene diene monomer), a thermosetting Liquid Silicone Resin (LSR), thermoplastic elastomers, PVC (polyvinylchloride).

In an advantageous example, the first portion has a flared shape of larger diameter intended to be oriented towards the connection device.

For example, the transfer device comprises a second rigid portion forming a conduit, to which the connection means are fastened, the second portion having for example a tubular shape.

Another object of the present application is an enclosure comprising at least one sealed connection device mounted in a wall of said enclosure, a transfer system comprising a transfer device according to the invention, a device for displacing the transfer device inside the enclosure to place the transfer device so as to allow components to be transferred through the sealed connection device, and means for mounting/dismounting the transfer device on the displacement device.

The first portion of the transfer device may be oriented so as to penetrate into a flange of the sealed connection device and partially into a flange 9 of the container.

Preferably, the first portion of the transfer device comprises a maximum cross section in the non-deformed state that does not allow it to pass through the first sealed connection device.

Advantageously, the means for mounting/dismounting the transfer device are configured to be actuatable with one hand.

According to an additional feature, the displacement device comprises at least one arm rotatably hinged relative to the sealed connection device so as to allow the transfer device to move closer or move away from the sealed connection device.

In one example of embodiment, the second portion of the transfer device has a cross section allowing it to pass through the sealed connection device without deforming.

In another example of embodiment, the enclosure comprises a glove port allowing the transfer device to be mounted/dismounted by means of a glove mounted in the glove port and to pass it through the sealed connection device.

According to an additional feature, the displacement device comprises a motorised means.

According to another additional feature, the enclosure comprises motorised means for locking a door of the sealed connection device and motorised means for opening the door of the sealed connection device.

Another object of the present application is a method for extracting the transfer device from the enclosure according to the present invention comprising:
a) Connecting a container on the connection device,
b) Opening the passage between the interior of the enclosure and the interior of the container,
c) Disconnecting the transfer device from the displacement device,
d) Deforming the first portion of the transfer device reducing its external dimensions allowing it to be extracted through the passage between the interior of the enclosure and the interior of the container,
e) Extracting the transfer device through the passage between the interior of the enclosure and the interior of the container,
f) Closing the passage between the interior of the enclosure and the interior of the container,
g) Disconnecting the container.

Another object of the present application is a method for installing a transfer device of the enclosure according to the invention comprising:
a′) Providing a container containing a transfer device according to the invention,
b′) Connecting said container on the connection device,
c′) Opening the passage between the interior of the enclosure and the interior of the container,
d′) Deforming the first portion of the transfer device reducing its external dimensions allowing it to be inserted through the passage between the interior of the container and the interior of the enclosure,
e′) Inserting the transfer device into the enclosure through the passage between the interior of the enclosure and the interior of the container,
f′) Connecting the transfer device to the displacement device,
g′) Closing the passage between the interior of the enclosure and the interior of the container,
h′) Disconnecting the container.

In one example of embodiment, the container is a glove system and wherein steps c), d) and e) or steps d′), e′) and f′) are performed through the glove of the glove system. According to another example of embodiment, the container is a rigid or flexible container and wherein steps c), d) and e) or steps d′), e′) and f′) are performed through a glove mounted in a glove port located near the connection device.

### BRIEF DESCRIPTION OF THE DRAWINGS

The present invention will be better understood based on the following description and appended drawings wherein:

FIG. 1 is a longitudinal sectional view of an enclosure provided with a transfer device according to one embodiment, the transfer device being in a docked position,

FIG. 2 is a longitudinal sectional view of an enclosure provided with a transfer device according to one embodiment, the transfer device being in a parking position,

FIG. 3 is a perspective view of the transfer device of FIGS. 1 and 2 according to one viewpoint.

FIG. 4 is a perspective view of the transfer device of FIGS. 1 and 2 according to another viewpoint.

FIG. 5 is a perspective view of a glove system that can be used to extract the transfer device from the enclosure.

FIG. 6 is a schematic representation of an enclosure provided with a sealed connection device and a transfer container.

FIG. 7A is a perspective view of an example of a system for quick mount/dismount with one hand that can be implemented between the chute and the hinge device.

FIG. 7B is a longitudinal sectional view of the system of FIG. 7A.

FIG. 7C is a sectional view of the system of FIG. 7B along the plane A-A.

FIG. 8 is a sectional view of an example of embodiment of the assembly between the two portions of a transfer device.

### DETAILED DISCLOSURE OF PARTICULAR EMBODIMENTS

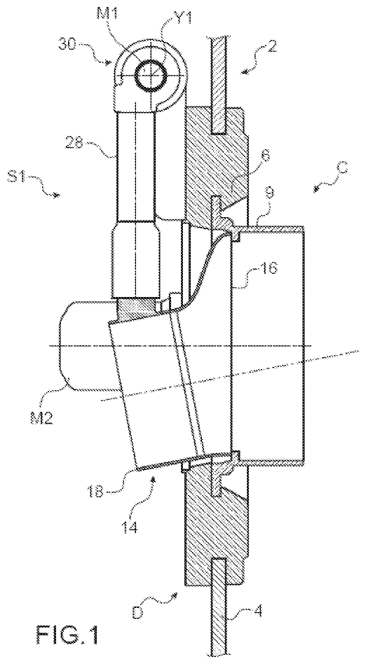

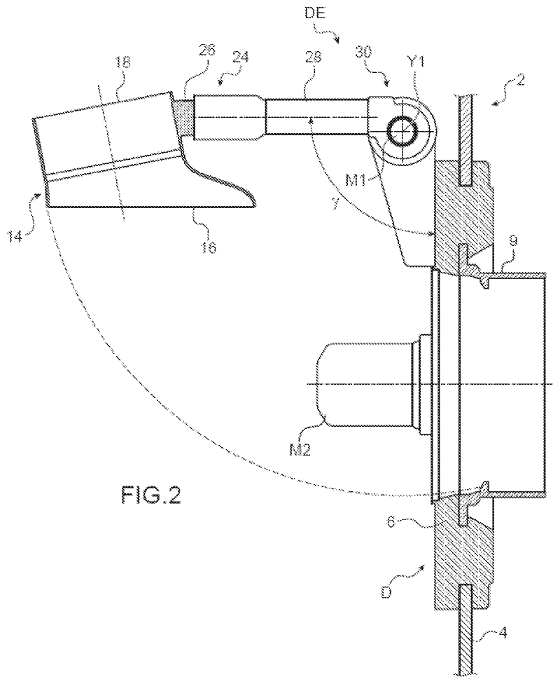

In FIGS. 1 and 2, an example of a sealed enclosure can be seen, shown in transparency, provided with an example of a transfer system S1, the transfer system being shown in different positions. The transfer system S1 allows guiding coming from outside towards an area of the internal volume of the enclosure. For example, these objects are caps contained in a bag and which are poured inside the enclosure. The system S1 is intended to facilitate the processing and/or transfer of objects/elements inside the enclosure, for example to facilitate the supply of objects/elements to a conveyor belt.

The enclosure 2 comprises walls delimiting a sealed volume. At least one of the walls 4 comprises a device D for sealed connection to an external sealed system, for example another enclosure, a bag-type rigid or flexible container. The device D is intended to allow connecting the internal volumes of the enclosure and of the external system in a sealed manner and to enable a sealed transfer between the two volumes, to protect the objects contained in the sealed volumes and/or protect the external environment of these objects. For example, the enclosure 2 may be part of an isolator system, specifically a containment area of the isolator, a sterile containment area, or a radioactive containment area, which may be used to manufacture products in the pharmaceutical, agri-food or nuclear industry, for example. The connection device D is mounted through a wall 4 of the enclosure 2.

Examples of sealed connection device are described in the document FR 2 695 343 and in the document U.S. Pat. No. 9,754,691.

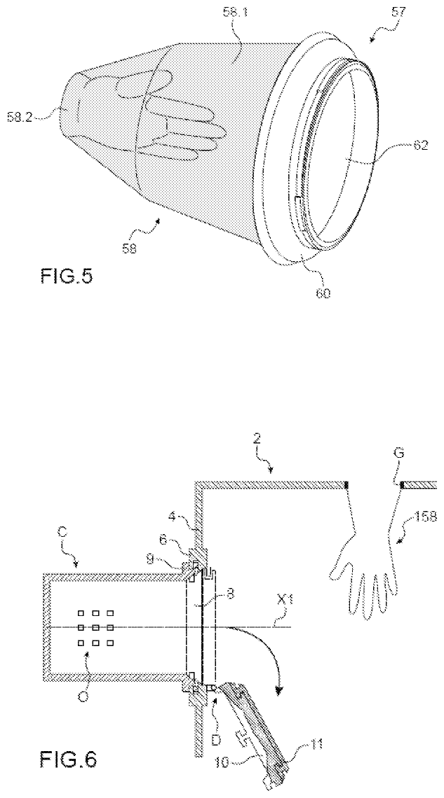

In FIG. 6, a schematic representation can be seen of the connection device and of a container in a connected state.

The sealed connection device D comprises a flange 6, known as alpha flange, mounted in the wall 4 and delimiting an opening 8, a door 10, known as alpha door, intended to close the opening 8 in a sealed manner. The sealed connection device D also comprises means of connection to an external system, for example a container C, also comprising a flange 9, known as beta flange, bordering an opening and a door 11, known as beta door, closing said opening in a sealed manner. For example, the means for connecting the flange 6 and the flange 9 are of the bayonet type. Each door is connected to its flange also by a bayonet connection or the alpha door is connected to the alpha flange alpha by a hinge and a latch. The connection device has an axisymmetry according to the axis X1.

An example of a procedure for connecting a container in a sealed manner to the enclosure will be briefly described with reference to FIG. 6. On the left side of FIG. 6, the closed container before its connection to the enclosure can be seen. The container contains objects O schematically shown, which one wishes to transfer into the enclosure. The transfer system is not shown.

The beta flange 9 of the container is secured in a sealed manner to the alpha flange 6 of the enclosure by means of a bayonet connection. Simultaneously, the beta door 11 of the container and the alpha door 10 of the enclosure are secured to each other in a sealed manner by a bayonet connection. The external faces of the alpha 10 and beta doors 11 are isolated from the internal volumes of the container and of the enclosure, the assembly formed by the two doors 10, 11 secured to each other may be removed by pivoting it about its axis, and afterwards displacing it into the enclosure, clearing a passage between the two volumes. The two volumes are then in communication in a sealed manner and the transfer of objects between the two volumes may be achieved through the passage.

The flange 9 of the container carries a seal which comes into contact with the external face of the flange 6 of the enclosure, this seal contributes to the delimitation of the passage between the two volumes.

The transfer system S1 comprises a transfer device 14 ensuring the guidance of the flow of objects, referred to as a chute and a displacement device DE of the chute 14 inside the enclosure and particularly relative to the sealed connection device D.

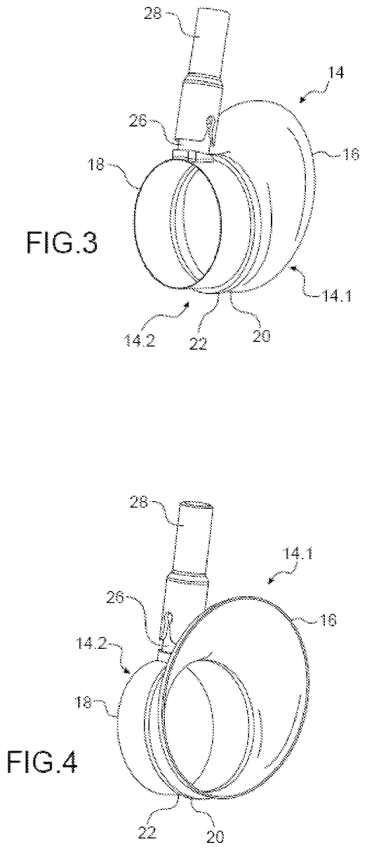

In the example shown in FIGS. 3 and 4, the chute 14 comprises a first portion 14.1 forming a conduit, a free end 16 of which is intended to penetrate into the flange 6 of the connection device D and partially into the flange 9 of the container, and to border the passage through the connection device, and a second portion 14.2, forming a conduit, the free end 18 of which is intended to pour elements into the enclosure.

The chute forms a conduit that transfers the elements of the container connected to the enclosure inside the enclosure.

The first portion 14.1 of the chute 14 has a flared shape so that the cross section of its free end 16 fills the section of the passage of the connection device and that the first portion connects the section of the passage of the connection device and the second portion 14.2. In the example shown, the free end 16 of the first portion 14.1 is bearing against the beta flange of the container.

In the example shown, the first portion 14.1 of the chute 14 comprises a second end 20 connected to a second end 22 of the second portion 14.2.

The second portion 14.2 is decentred downwards relative to the passage of the connection device to be in the flow for pouring the components. The first portion 14.1 then has a shape filling the space between the second end 22 of the second portion 14.2 and the entrance of the passage of the connection device. Moreover, the first portion 14.1 comprises a bottom portion having a shape ensuring the absence of obstacles for the objects pouring from the container and ensuring the absence of slope opposing the flow of the objects from the container towards the enclosure.

In the example shown, the first portion 14.1 does not have an axisymmetry and has a “cap” shape.

Furthermore in the example shown, the sectional views show that the first portion 14.1 has a curved section (FIGS. 1 and 2).

Any other shape of the first portion ensuring the absence of operation in the bottom portion forming an obstacle to the pouring of components may be implemented.

According to the invention, the first portion is made of a material having elastic deformation properties so that it can be sufficiently deformed to pass through the passage of the connection device. For example, the material of the first portion 14.1 is a synthetic material, selected from elastomers, for example thermosetting silicone, thermosetting EPDM (ethylene propylene diene monomer), thermosetting Liquid Silicone Resin (LSR), thermoplastic elastomers, PVC (polyvinylchloride).

The thickness of the first portion 14.1 made of flexible material is for example between 1 mm and 5 mm.

The elastic deformation properties of the material of the first portion 14.1 are considered relative to a range of forces that may be exerted by an operator with their hand, for example between 5 N and 100 N.

Nevertheless, the mechanical properties of the material and the thickness of the first portion ensure that it retains its shape when no force is exerted on it.

The second portion 14.2 is rigid in the example shown. It may advantageously be made of stainless steel. In the present application “a rigid portion” means a portion that cannot deform or deforms little by applying a usual intensity force during the handling in normal operation of the transfer system.

In the example shown, the second portion 14.2 has a tubular shape, alternatively it has a frustoconical and/or curved shape so as to form an elbow.

Preferably, the first portion 14.1 is clipped on the second portion 14.2. In FIG. 8, a sectional view of an example of chute can be seen wherein the first portion is clipped on the second portion. In this example, the second portion 14.2 forms the male portion, it is provided with a lug 23 of triangular section around its entire circumference close to its end 22. The portion 14.1 forms the female portion, its end 20 comprises a radial groove 25 configured to accommodate the lug with clamping and ensure a connection by clipping the first and second portions. During the mounting of the first portion 14.1 on the second portion 14.2, the end 20 of the first portion 14.1 is deformed radially outwardly to accommodate the annular lug ensuring a clamping of the first portion 14.1 on the second portion 14.2.

Preferably, the angle formed between the lateral face of the second portion 14.2 and the base of the lug is less than 90° improving the hooking of the first portion on the second portion.

Implementing connection by clipping offers the advantage of an easy dismount of the flexible portion and its easy replacement, and offers good cleanability. According to other variants, the first portion 14.1 and the second portion 14.2 may be assembled by screwing or press fitting. These assembly types have the advantage of being suitable for autoclaving. According to another variant, the first portion 14.1 and the second portion 14.2 are assembled by bonding, nevertheless the resistance to the autoclaving is generally not so good.

As a variant, the chute comprises a body made entirely of an elastically deformable material and a ring made of rigid material of cross section smaller than the passage section of the connection device, and allowing the chute to be connected to the displacement device.

As another variant, the first portion comprises a reinforcement or reinforcements, for example metallic that ensure the retention of the first portion in a given shape while allowing its deformation and its reduction of volume for its transfer through the connection device.

In the example shown, the displacement device comprises an arm 28 rotatably hinged by means of a pivot hinge 30 according to the axis Y1 on the wall of the enclosure supporting the displacement device. Advantageously, the pivot hinge 30 is fastened on the flange 6, which avoids having to pierce the wall of the enclosure to fasten the transfer system. The arm 28 can pivot between a parking position for example that shown in FIG. 2 and a docked position, wherein the chute docks with the connection device, as shown in FIG. 1. The parking position corresponds to a non-operational position of the transfer device. In the example shown, an angle γ=90° separates the parking position and the docked position of the arm 28. The angle γ may take another value that places the chute in an advantageous parking position favouring, for example, the opening/closing of the door of the connection device or the laminar flow or the displacements inside the enclosure.

As a variant, the displacement device comprises a plurality of arms hinged with one another so as to apply to the chute 14 more complex displacements inside the enclosure.

Furthermore, the displacement device may be fastened to a wall other than that supporting the connection device.

Furthermore, the displacement device is advantageously motorised. The pivot hinge 30 comprises an electric motor M1. The electric motor is fastened on the alpha flange 6. The electric supply of the motor M1 is carried out through the alpha flange 6.

Advantageously, the displacement device is equipped with a plurality of arms and a plurality of motors, allowing more complex trajectories, for example to bring the detachable portion of the chute directly in the container connected to the transfer device D.

Furthermore, when at least one portion of the connection device is automated, for example the control of the latch of the alpha door of the connection device and the opening of the alpha door, by implementing one or more electric motors, the electric cables for supplying and controlling the electric motor M1 of the transfer device and the motors of the connection device are brought together and run through a single drill hole made through the alpha flange. In FIGS. 1 and 2, a motor M2 actuating the latch of the alpha door can be seen.

This assembly makes it possible to offer a high level of integration and simplify the equipping of an enclosure. Furthermore, the leak risks are reduced.

The chute also comprises means for connecting 24 the chute to the displacement device DE. In this example, the connection means 24 include a rod 26 preferably fastened to the second portion 14.2 of the chute and provided with a second end of means for quickly and easily connecting/disconnecting the chute to/from the displacement device DE. Fastening the rod 26 on the rigid portion of the chute allows its displacement to be more accurate and limits its deformation under its weight.

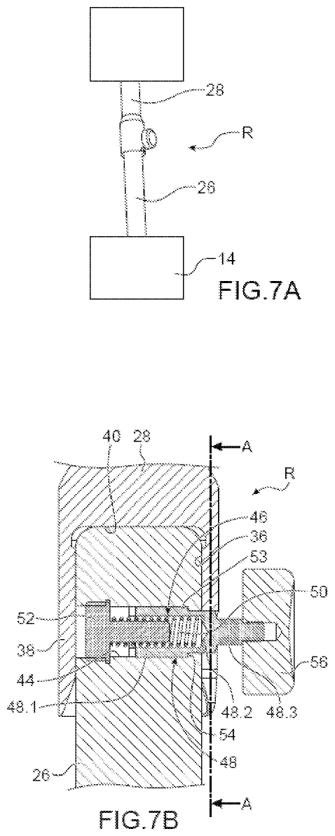

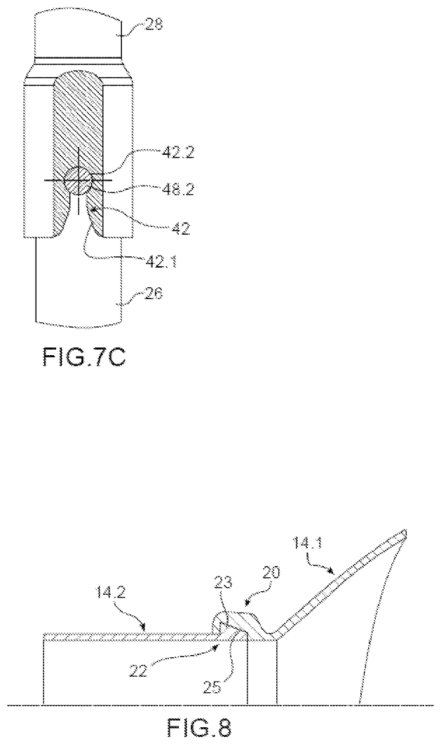

In FIGS. 7A to 7C, an example of device for connecting the chute to the displacement device can be seen.

Advantageously, the chute is removably mounted on the hinge device, which allows easily removing, cleaning and sterilising it, for example in an autoclave. An easy cleaning is particularly interesting since the chute is in contact with the components during transfers, and requires careful cleaning.

Preferably, fastening the chute 14 on the displacement device DE is performed by a quick mount/dismount system R with one hand.

In FIGS. 7A to 7C, an example of a quick mount/dismount system R can be seen.

The system R is disposed between the arm 28 of the displacement device DE and the rod 26 fastened on the chute 14. For example, the arm 28 comprises at its free end a housing 36 sized to accommodate the free end of the rod 26. The housing 36 comprises a lateral wall 38 and a bottom 40. The lateral wall 38 comprises a notch 42 (FIG. 7C) extending longitudinally over the thickness of the housing 36. The notch 42 comprises a flared insertion portion 42.1 opening into the free end of the arm 28 and a circular-shaped immobilisation portion 42.2.

The rod 26 fastened to the chute comprises a transverse bore 44 open-through and accommodating an axial locking mechanism 46 cooperating with the notch 42.

The locking mechanism 46 comprises a locking rod 48 movable transversely in the bore 44 and pushed outwards by means of a spring 50 mounted in compression between the rod 48 and a transverse stop 52. In this example, the stop is formed by a bolt screwed into the bore.

The locking rod 48 comprises three axial portions 48.1, 48.2 and 48.3 with a decreasing diameter in the direction of the thrust force exerted by the spring.

The transverse bore 44 comprises a shoulder 53 cooperating with a shoulder 54 connecting the external lateral faces of the axial portions 48.1 and 48.2. The diameter of the axial portion 48.2 is substantially equal to that of the immobilisation portion 42.2.

The end of the locking rod 48 carries an actuation button 56.

The operation of the system is as follows:

The operator presses on the actuation button 56, displacing the locking rod 48 and compressing the spring 50, the portion 48.3 then fits within the immobilisation portion 42.2 of the notch. Its diameter being smaller than the smallest transverse dimension of the notch 42, the portion 48.3 can slide in the notch 42, which allows removing the end of the rod 26 from the housing 36, and separating the chute from the hinge device.

Placing the chute again on the hinge device is performed by pressing on the actuation button and by inserting the portion 48.3 into the notch 42.

This manipulation may be done with one hand.

The removal of the chute in view of its cleaning will now be described.

Initially the connection device is closed, nothing is docked on the connection device.

The chute is placed in a non-docked position, for example in the parking position as shown in FIG. 2, or for example in an intermediate position facilitating the access to its quick mount/dismount system R.

A glove system shown in FIG. 5 is mounted on the flange of the connection device. This glove system comprises a beta portion 57 and a glove 58 the cuff 58.1 of which is fastened in a sealed manner on the beta flange and the portion 58.2 receiving the hand is retracted inside the cuff 58.1.

The beta portion 57 comprises a beta flange 60 and a beta door 62. The beta flange 60 is fastened to the alpha flange 6 of the connection device D, the beta door 62 is fastened to the alpha door 10. The latch of the connection device is controlled to release the alpha door and the opening of the alpha door to which the beta door is connected is controlled.

The passage through the connection device is then free.

The operator places their hand in the glove and enters their hand into the enclosure. They access the quick mount/dismount system R of the chute. The operator presses on the actuation button 56, which unlocks the rod 26 of the arm 28. The chute is then released from the displacement device DE. This operation is done with one hand.

Afterwards, the operator deforms the flexible portion by pressing it between their fingers to pass it through the connection device. The rigid portion that has a diameter smaller than that of the passage of the connection device passes through easily. The chute is then outside of the enclosure inside the cuff of the glove.

The closing of the doors and the locking of the alpha door are controlled. The glove system can be detached from the alpha portion. The chute is isolated in the glove system and may be brought into an installation for cleaning and possibly autoclaving.

When the chute has been cleaned and possibly has undergone autoclaving, it is re-inserted into the enclosure. For this, it is disposed inside the glove system, then it is inserted into the enclosure by deforming the flexible portion to pass through the connection device. The flexible portion returns to its initial shape as soon as it is inside the enclosure. The chute is connected afterwards to the arm 28 via the quick mount/dismount system R. The connection device is closed. The glove system is separated from the connection device.

The installation of a new chute is done in the same manner.

The transfer system is once again ready to be used.

The chute according to the present invention can be used in enclosures provided with any type of connection device. It is particularly advantageous in the case of an automated connection device that does not require additional access by the operator to the inside of the enclosure to actuate the connection device. The chute is therefore particularly adapted to enclosures comprising a reduced number of accesses.

Furthermore, implementing an elastically deformable portion that is intended to come into contact with the connection device has the advantage of reducing the risks of damaging the connection device when the chute comes into contact with the connection device. Moreover, this elastically deformable portion allows the chute to be applied firmly against the connection device to eliminate any passage between the chute and the connection device and avoid the falling of objects, particularly of small size. The chute according to the present invention allows small-sized objects to be transferred safely.

Indeed, the elastically deformable portion allows compensating for docking defects with the connection device.

The chute according to the invention may also be used with a manual-opening connection device, in this case the displacement of the chute is generally performed manually. The removal of the chute is then performed in the following manner.

An access, referred to as glove port G schematically shown in FIG. 6, is provided through a wall of the enclosure near the connection device. The operator connects a container or bag provided with a beta portion to the connection device and a glove 158 is connected to the glove port G. The operator inserts their hand into the glove, opens the dual-door, unhooks the chute, places the chute in the container or the bag and closes the dual-door. They remove their hand from the glove and disconnect the container or the bag containing the chute, which is transferred for example towards a cleaning installation.

As a variant, the connection device is automated and the enclosure comprises a glove port near the connection device. The operator connects a container or a bag to the connection device and mounts a glove in the glove port. Afterwards, they control the opening of the dual-door, pass their hand into the glove, unhook the chute, place the chute in the container or the bag, remove their hand from the glove, control the closing of the dual-door and remove the loaded container or the bag from the chute. In this configuration, safety controls prohibiting access to the glove during the phases for opening/closing the dual-door are advantageously provided.

As another variant, the chute is inserted into the enclosure and extracted from the enclosure by a dual-door connection device other than that through which the transfer took place, for example a dual-door connection device located nearby.

What is claimed is:

1. Transfer device intended to be mounted in an enclosure provided with at least one sealed connection device, said transfer device comprising at least one first portion forming a conduit for the flow of elements into said enclosure, and means for connecting to a device for displacing said transfer device inside the enclosure, said first portion having elastic deformation properties so as to be able to be elastically deformed by an operator and to allow after deformation the transfer device to pass through the connection device.

2. Transfer device according to claim 1, wherein the first portion is made of a material selected from elastomers, for example thermosetting silicone, thermosetting EPDM (ethylene propylene diene monomer), a thermosetting Liquid Silicone Resin (LSR), thermoplastic elastomers, PVC (polyvinylchloride).

3. Transfer device according to claim 1, wherein the first portion has a flared shape of larger diameter intended to be oriented towards the connection device.

4. Transfer device according to claim 1, wherein the transfer device comprises a second rigid portion forming a conduit, to which the connection means are fastened, the second portion having for example a tubular shape.

5. Enclosure comprising at least one sealed connection device mounted in a wall of said enclosure, a transfer system comprising a transfer device according to claim 1, a device for displacing the transfer device inside the enclosure to place the transfer device so as to allow components to be transferred through the sealed connection device, and means for mounting/dismounting the transfer device on the displacement device.

6. Enclosure according to claim 5, wherein the first portion of the transfer device is oriented so as to penetrate into a flange of the sealed connection device and partially into a flange of the container.

7. Enclosure according to claim 5, wherein the first portion of the transfer device comprises a maximum cross section in the non-deformed state that does not allow it to pass through the first sealed connection device.

8. Enclosure according to claim 5, wherein the means for mounting/dismounting the transfer device are configured to be actuatable with one hand.

9. Enclosure according to claim 5, wherein the displacement device comprises at least one arm rotatably hinged relative to the sealed connection device so as to allow the transfer device to move closer or move away from the sealed connection device.

10. Enclosure according to claim 5, wherein the second portion of the transfer device has a cross section allowing it to pass through the sealed connection device without deforming.

11. Enclosure according to claim 5, comprising a glove port allowing the transfer device to be mounted/dismounted by means of a glove mounted in the glove port and to pass it through the sealed connection device.

12. Enclosure according to claim 5, wherein the displacement device comprises a motorised means.

13. Enclosure according to claim 5, comprising motorised means for locking a door of the sealed connection device and motorised means for opening the door of the sealed connection device.

14. Method for extracting the transfer device from the enclosure according to claim 5 comprising:
a) Connecting a container on the connection device,
b) Opening the passage between the interior of the enclosure and the interior of the container,
c) Disconnecting the transfer device from the displacement device,
d) Deforming the first portion of the transfer device reducing its external dimensions allowing it to be extracted through the passage between the interior of the enclosure and the interior of the container,
e) Extracting the transfer device through the passage between the interior of the enclosure and the interior of the container,
f) Closing the passage between the interior of the enclosure and the interior of the container,
g) Disconnecting the container.

15. Method for installing a transfer device of the enclosure according to claim 5, comprising:
a) Providing a container containing the transfer device,
b) Connecting said container on the connection device,
c) Opening the passage between the interior of the enclosure and the interior of the container,
d) Deforming the first portion of the transfer device reducing its external dimensions allowing it to be inserted through the passage between the interior of the container and the interior of the enclosure,
e) Inserting the transfer device into the enclosure through the passage between the interior of the enclosure and the interior of the container,
f) Connecting the transfer device to the displacement device,
g) Closing the passage between the interior of the enclosure and the interior of the container,
h) Disconnecting the container.

16. Extraction or installation method according to claim 14, wherein the container is a glove system and wherein steps c), d) and e) or steps d′), e′) and f′) are performed through the glove of the glove system.

17. Extraction or installation method according to claim 14, wherein the container is a rigid or flexible container and wherein steps c), d) and c) or steps d′), e′) and f′) are performed through a glove mounted in a glove port located near the connection device.
